(19) United States
(12) Patent Application Publication
(10) Pub. No.: US 2009/0249329 A1
(43) Pub. Date: Oct. 1, 2009

(54) LIMITED SERVICE LIFE THROUGH VIRTUALIZED SERVICE IMAGES

(76) Inventor: Sambit Kumar Dash, Bangalore (IN)

Correspondence Address: SCHWEGMAN, LUNDBERG & WOESSNER/NOVELL, PO BOX 2938, MINNEAPOLIS, MN, 55402, US

(21) Appl. No.: 12/054,664

(22) Filed: Mar. 25, 2008

(51) Int. Cl. G06F 9/46

(52) U.S. Cl. 718/1

(57) ABSTRACT

Techniques for limited service life through virtualized service images are presented. A software application is embodied as a service within a virtual machine (VM) image. Licensing restrictions for the software application are carried with or accessible from VM image. Each time the VM is instantiated on a target processing environment from the VM image, the licensing restrictions are enforced against the software application to thereby limit the service life of the software application embedded within the VM image.

### BACKGROUND

Software is rapidly becoming viewed as a service. These days it seems, similar to physical services, software is never really owned or permanently possessed by a purchaser (user). In fact, this appears to be the goal of the software industry and software vendors albeit the goal has not fully materialized as hoped for by the industry.

Software as a Service (SaaS) is a popular mechanism for delivering software via the World-Wide Web (WWW) over the Internet. Most if not all SaaS that exists today is achieved via a WWW browser. With SaaS, a user pays for using the software for a number of iterations or for a limited period of time. Thus, the traditional perpetual software licensing model is moving towards a limited time software licensing scheme.

One problem with today's techniques for SaaS is that not all software is browser-enabled. So, rather than porting the software to a browser-enabled format, software is usually just distributed via a browser but still has to execute on a user's computer much like software that is traditionally purchased at a brick-and-mortar store on a CD-ROM.

Another issue with SaaS is that some software is highly coupled or dependent on other software or user-specific processing environment configurations. That is, software can and typically does have a variety of hardware and software dependencies. Many times, it is too difficult to rewrite this type of software and decouple the software from the software's existing dependencies. As a result, such types of software are not capable of being delivered as a service via a browser-enabled format because it is impractical to do so.

Yet, software vendors want to pursue the SaaS model because: it reduces support issues associated with maintaining older versions of a product; it increases revenue because users have to upgrade or move to newer versions of the product at data certain times; it delivers the product in a time efficient and cost efficient manner on demand to the consumer; and it reduces development and integration expenses because a plurality of user processing environments and dependencies do not have to be accommodated during a release of a product.

Thus, what are needed are techniques, which allow for improved software delivery and license enforcement with expansion of SaaS capabilities.

### SUMMARY

In various embodiments, techniques for limited service life for virtualized service images are presented. More specifically, and in an embodiment, a method is provided that limits the service life of a virtual machine image for a software application. A software application is packaged as a service within a virtual machine (VM) image. Next, licensing restrictions defined by a software vendor for the software application are added to the VM image. Finally, the VM image is delivered to a target processing environment from which the VM is to be loaded and processed and the licensing restrictions enforced during the load of the VM within the target processing environment.

### BRIEF DESCRIPTION OF THE DRAWINGS

FIG. 1 is a diagram of a method that limits the service life of a virtual machine (VM) image for a software application, according to an example embodiment.

FIG. 2 is a diagram of method for enforcing service life restrictions for a software application within a Basic Input/Output System (BIOS) instruction set for a VM image, according to an example embodiment.

FIG. 3 is a diagram of a method for enforcing service life restrictions for a software application during modes of operation for a VM that processes the software application, according to an example embodiment.

FIG. 4 is a diagram of a VM service life restriction enforcement system, according to an example embodiment.

### DETAILED DESCRIPTION

A “processing environment” refers to one or more physical processing devices organized within a local network. For example, several computers connected via a local area network (LAN) may collectively be viewed as a processing environment. The processing environment also refers to software configurations of the physical processing devices, such as but not limited to operating system, file system, directory service, etc.

A “virtual processing environment” refers to a software constructed sub processing environment that is carved out from or superimposed on a portion of a physical processing environment. A single physical processing environment can have a plurality of different or cloned “virtual processing environments.”

A “virtual machine” (VM) may be viewed as a virtual processing environment discussed and described above. The VM is a logical machine that is independent of its physical process environment or physical machine. It may include its own operating system (OS), its own file system (FS), its own directory services, etc., which may each be different from the physical processing environment.

According to an embodiment, the techniques presented herein are implemented in products associated and distributed by Novell®, Inc. of Provo, Utah.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit various aspects of the invention.

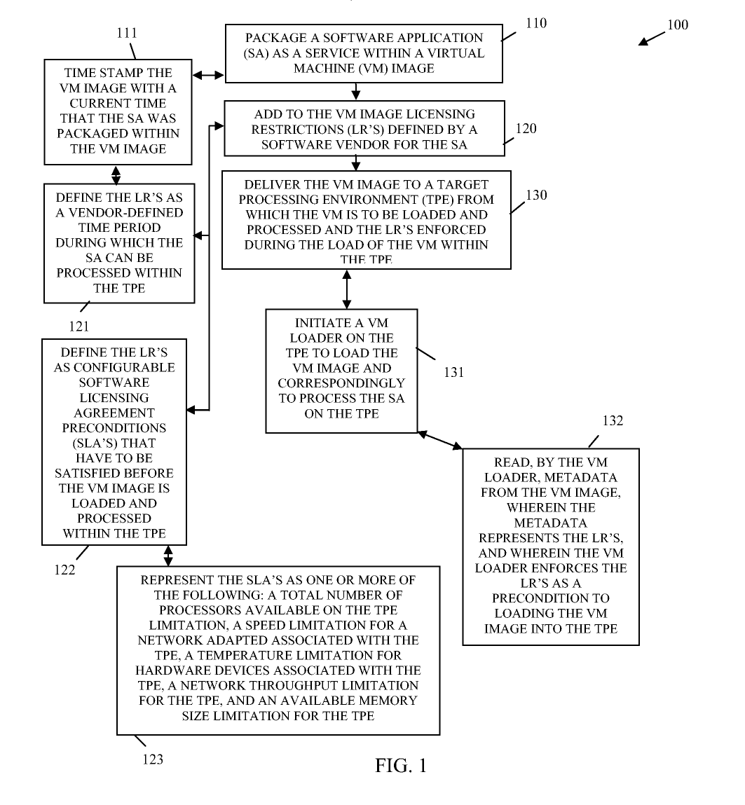

It is within this initial context, that various embodiments of the invention are now presented with reference to the FIGS. 1-4.

FIG. 1 is a diagram of a method 100 that limits the service life of a virtual machine (VM) image for a software application, according to an example embodiment. The method 100 (hereinafter “VM image packaging service”) is implemented as instructions in a machine-accessible and readable medium. The instructions when executed by a machine (processing device, computer, etc.) perform the processing depicted in FIG. 1. The VM image packaging service is also operational over and processes within a network. The network may be wired, wireless, or a combination of wired and wireless. In some cases, the network is a wide-area network (WAN), such as the Internet.

At 110, the VM image packaging service packages a software application as a service within a VM image. The software application represents a set of instructions that can process on a machine, such as the virtual machine. The VM image includes software and hardware dependency settings that the software application needs to successfully process. In some cases, this may include some software modules or libraries that are loaded within the VM image, such that when the software application processes within the VM the needed software modules and libraries are also loaded and available with the VM. The VM image is a self contained processing environment, including operating system (OS) in some cases, for the software application to process.

So, rather than attempting to rewrite a legacy software application to make it available as a WWW browser-enabled service. The legacy software application remains unchanged and is packaged within a VM image, when the image is loaded as a VM; the VM is a self-contained processing environment that permits the software application to execute. The VM, via the VM image, can be configured to run on any desired target machine or target processing environment.

According to an embodiment, at 111, the VM image packaging service time stamps the VM image with a current time that the software application was packaged within the image. The current time can in some cases represent a date and time of day that a user purchases the software application and is attempting to download it over a network, such as the Internet as the VM image. In an embodiment, the time stamp is in a separate file represented as metadata for the VM image.

At 120, the VM image packaging service adds to the VM image licensing restrictions, which are defined by a software vendor of the software application. That is, the software vendor may customize licensing restrictions for a particular user that is purchasing or is to receive the software application. The licensing restrictions represent conditions that indicate when the software application can process within the VM that it is encapsulated within and when the software application cannot process within the VM.

According to an embodiment, the licensing restrictions are also represented as metadata in a separate file from the VM image, similar to the time stamp of the VM image discussed above in a particular described embodiment. It is the VM loader (discussed below), which eventually instantiates a VM in a target processing environment using the VM image that understands how to locate and interpret the metadata file(s) associated with the time stamp for the VM image and the licensing restrictions.

In an embodiment, at 121, the VM image packaging service defines the licensing restrictions as a vendor-defined time period during which the software application can be processed within a target process environment to which the VM is to be installed and processed within. So, as an example, the VM image itself may be associated with a time stamp of January 1 and the licensing restrictions may indicate a date certain calendar date of February 1 or a time period, such as 30 days. The January 1 time stamp and the licensing restriction of 30 days are each included with the VM image that represents the processing environment for the software application.

In another case, at 122, the VM image packaging service defines the licensing restrictions as a variety of configurable software licensing agreement preconditions. The preconditions have to be satisfied by a VM loader within a target processing environment before the VM image is loaded and processed within that target processing environment. Any desired precondition can be included as part of a customized license for the software application.

Again, in an embodiment, the preconditions are carried as metadata for the VM image and may be represented in a separate file that the VM loader knows how to locate and how to interpret (similar to the discussion above with respect to the time stamp and the licensing restrictions example embodiments).

For example, at 123, the VM image packaging service represents the software licensing agreement preconditions as one or more of the following: a total number of processors available on the target processing environment; a speed limitation for a network adapted associated with the target processing environment; a temperature limitation for hard devices associated with the target processing environment; a network throughput limitation for the target processing environment; an available memory size limitation for the target processing environment; and the like.

At 130, the VM image packaging service delivers the VM image to a target processing environment. The target processing environment is associated with a target machine or client of a user that purchases or is to lawfully acquire the software application as the VM image. In other words, the user may not be required to purchase the software and may acquire it by doing something else such as agreeing to usage requirements, etc. Once a user is to acquire the software application, the user's target processing environment is inspected and the software application is embedded within a VM image for that target processing environment via the processing discussed above at 110. The software vendor than adds the licensing restrictions for the usage restrictions that the user agreed to via the processing at 120. This can be done via metadata in a separate file that is associated with the VM image. So, the software licensing restrictions are associated with the VM image. At 130, the VM image is delivered over the network to the target processing environment of the user.

A VM loader, which may accompany the VM image or which may pre-exist in the target processing environment, then attempts to load the VM image as a VM that includes the software application on the target processing environment. During the load process for the VM image, within the target processing environment, the VM loader enforces the licensing restrictions acquired for or on behalf of the VM image.

Accordingly, at 131, the VM loader is initiated on the target processing environment for purposes of loading the VM image and to correspondingly processing the software application on the target processing environment within the VM that is instantiated.

According to an embodiment, at 132, the VM loader reads metadata associated with the VM image. The metadata represents the licensing restrictions. The VM loader enforces the licensing restrictions as a precondition to loading the VM image into the target processing environment. Essentially, the licensing restrictions are embodied as metadata carried with the VM image of the VM that includes a self-contained and executable version of the software application, and the licensing restrictions are enforced when the VM loader loads the VM image as the VM within the target processing environment.

So, whenever the user attempts to initiate the VM, the VM loader uses the VM image to instantiate the VM having the software application and decides whether to permit the VM to load and process within the target processing environment or whether to not permit the VM to load in response to evaluation of the licensing restrictions that are associated within the VM image.

Therefore, software is delivered as a service via a VM image and the software vendor ensures a limited lifecycle of the software by encapsulating and associating licensing restrictions with the VM image; the restrictions are regularly evaluated each time the VM is loaded and processed on the target processing environment of the user.

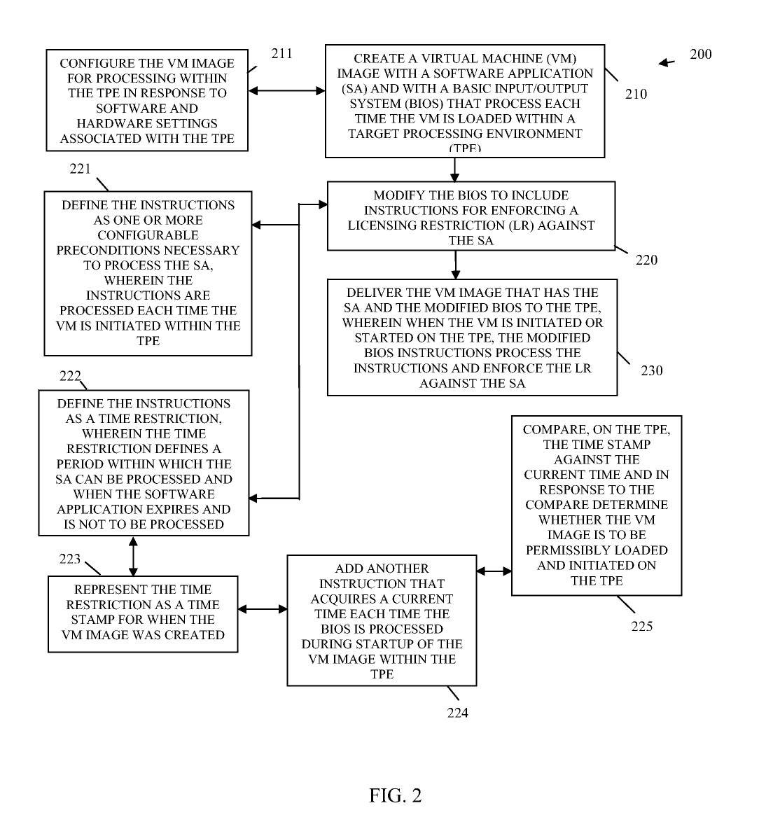

FIG. 2 is a diagram of method 200 for enforcing service life restrictions for a software application within a Basic Input/Output System (BIOS) instruction set for a VM image, according to an example embodiment. The method 200 (herein after referred to as “VM BIOS service”) is implemented in a machine-accessible and readable medium as instructions, which when accessed by a machine performs the processing depicted in the FIG. 2. The VM BIOS service is also operational over a network; the network may be wired, wireless, or a combination of wired and wireless.

The VM BIOS service represents an alternative and in some cases an enhanced approach to the VM image packaging service represented by the method 100 of the FIG. 1.

At 210, the VM BIOS service creates a VM image with a software application and with a BIOS instruction set. The BIOS for the VM (instantiated from the VM image) is similar to a hardware BIOS for a physical machine in that each time the VM is instantiated (booted, restarted, loaded, etc.) the VM BIOS instruction set is processed.

In an embodiment, at 211, the VM BIOS service configures the VM image for processing within the target processing environment in response to software and hardware settings associated with the target processing environment. So, a user that it to lawfully or legitimately receive a software application has a VM created for that user's target environment.

It is noted that in some cases, the VM image is entirely independent of the target processing environment. In other words, it includes its own OS and support modules to run on time of or within a partition of the target processing environment. In other cases, as described at 211 the VM image includes some aspects of the target processing environment, such as OS, caching, memory management, etc. and in such situations the VM image is tailored for the target processing environment.

At 220, the VM BIOS service modifies the VM BIOS to include instructions for enforcing a licensing restriction against the software application. That is, the VM BIOS is configured to enforce and dynamically and in real time process conditions or policy associated with the licensing restrictions, which are embedded within the VM BIOS.

According to an embodiment, the instructions may identify a virtual hard disk or virtual resource, such as a file for the licensing restrictions. In this case, the VM BIOS service validates the existence of the virtual hard disk (licensing restrictions) by acquiring the file and processing the restrictions (additional instructions) within the file. So, the instructions in the VM BIOS can be to verify the existence of the virtual resource (licensing restrictions file) and validate it by processing the instructions of the file (licensing restrictions for the software application).

According to an embodiment, at 221, the VM BIOS service defines the instructions as one or more configurable preconditions that are necessary to process the software application within the VM. Again, the instructions of the VM BIOS are processed each time the VM is initiated via the VM image within the target processing environment.

In one case, at 222, the VM BIOS service defines the instructions as a time restriction. The time restriction defines a period within which the software application can be processed. Moreover, when the time restriction expires the software application is not loaded and not capable of being processed with the VM.

As an example, consider, at 223, that the VM BIOS service represents the time restriction as a time stamp for when the VM image was initially created. At 224, the VM BIOS service adds another instruction to the VM BIOS that dynamically acquires in real time a current time (current date and time of day) each time the VM BIOS is processed during a startup of the VM image within the target processing environment. At 225, the VM BIOS service compares, within the target processing environment, the time stamp against the current time and in response to the compare processing determines whether the VM image is to be permissibly loaded and initiated on the target processing environment. A policy or condition may indicate that if the time stamp is within a threshold of the current time, then the software application can be loaded within the VM from the VM image but if not then the software application cannot be loaded within the VM.

At 230, the VM BIOS service delivers the VM image, which has the software application, and delivers the VM BIOS to the target processing environment. The VM is initiated or started on the target processing environment by loading the VM image and the modified BIOS instructions are processed. This results in dynamic and real time enforcement of the licensing restrictions against the software application each and every time the VM is started on the target processing environment from the VM image.

The VM BIOS service demonstrates another approach to ensuring a limited lifecycle of software delivered as a service via a VM image over a network. The first approach added metadata licensing restrictions to the VM image that a VM loader recognizes and enforces; the VM BIOS service approach includes VM BIOS that processes instructions each time the VM is started and the instructions enforce the licensing restrictions.

In some case, once a VM having an executable software application is loaded and processed within a target processing environment, the VM may never or may rarely if ever terminate. Thus, the VM may exceed the expected life cycle of the licensing restrictions. The processing associated with the method 300 is now discussed to address this particular situation.

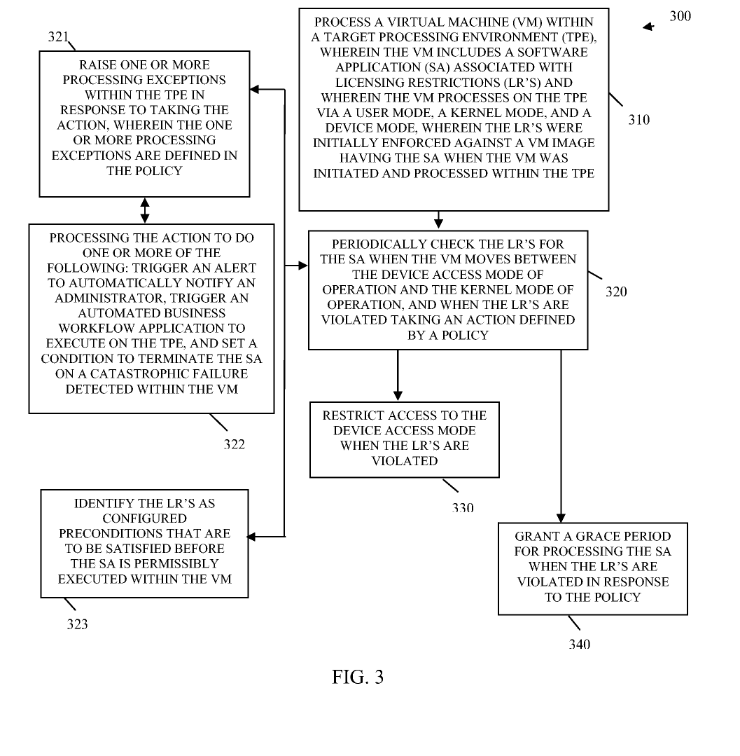

FIG. 3 is a diagram of method 300 for enforcing service life restrictions for a software application during modes of operation for a VM that processes the software application, according to an example embodiment. The method 300 (herein after referred to as “VM licensing mode enforcement service”) is implemented in a machine-accessible and readable medium as instructions, which when accessed by a machine performs the processing depicted in the FIG. 3. The VM licensing mode enforcement service is also operational over a network; the network may be wired, wireless, or a combination of wired and wireless.

In an embodiment, the VM licensing mode enforcement service compliments and enhances the processing associated with the methods 100 and 200 of the FIGS. 1 and 2, respectively. That is, the methods 100 and 200 are directed to packaging software applications in a VM and permit the licensing restrictions to be enforced when the VM image is loaded and the VM initiated on a target process environment; whereas, the VM licensing mode enforcement service permits those licensing restrictions to be continually and regularly enforced against the software applications when the VM processes on the target processing environment. So, if licensing restrictions were satisfied and the VM initiated on the target processing environment, the VM licensing mode enforcement service periodically checks to ensure the licensing restrictions remain valid during operation of that VM.

At 310, the VM licensing mode enforcement service processes a VM within a target processing environment. The target processing environment is associated with a user that is to receive a software application, which is included and processes within the VM and its virtual processing environment on top of the target processing environment.

The VM is instantiated on the target processing environment via a VM image. The techniques for creating the VM image were discussed in detail above with reference to the methods 100 and 200 of the FIGS. 1 and 2, respectively. The VM image also includes licensing restrictions for the software application.

Furthermore, the VM includes three modes of processing: a user mode, a kernel mode, and a device access mode.

At 320, the VM licensing mode enforcement service periodically checks the licensing restrictions for the software application when the VM machines moves back and forth between a kernel mode and a device access mode of operation. When the licensing restrictions are violated, the VM licensing mode enforcement service takes an action that is driven by a policy.

According to an embodiment, at 321, the VM licensing mode enforcement service raises one or more exceptions within the target processing environment in response to taking the action. The one or more exceptions are defined in the policy.

For example, at 322, the VM licensing mode enforcement service processes the action to do a variety of things, such as: trigger an automatic alert to notify an administrator of the situation; trigger an automated business workflow application to execute on the target processing environment; and/or set a condition to terminate the software application and the VM on catastrophic failure detected within the VM.

In an embodiment, at 323, the VM licensing mode enforcement service identifies the licensing restrictions as configured preconditions that are to be satisfied before the software application is to be permissibly processed within the target processing environment. The configured preconditions can be related to dynamically detected circumstances, such as number of processors and available memory on the target processing environment that are compared against threshold values set in the preconditions. In other cases the preconditions can be related to time-based or temporal restrictions. Example preconditions were discussed in detail above with reference to the methods 100 and 200 of the FIGS. 1 and 2, respectively.

In a case, at 330, the VM licensing mode enforcement service restricts access to the device access mode when the licensing restrictions are violated. So, immediate action can restrict access to the software application when licensing restrictions are violated. This fills the potential void not addressed by the methods 100 and 200, discussed above.

In another situation, at 340, the VM licensing mode enforcement service grants a grace period for processing the software application when the licensing restrictions are violated in response to the policy. So, the policy can state that the user is permitted to still use the software application for a configured grace period of time. In such a situation, the user may be dynamically notified that the licensing restrictions were violated and that a grace period of usage is in effect and that usage will cease at the end of the grace period.

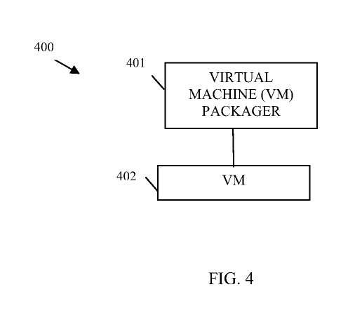

FIG. 4 is a diagram of a VM service life restriction enforcement system 400, according to an example embodiment. The VM service life restriction enforcement system 400 VM service life restriction enforcement system 400 is implemented as instructions on or within a machine-accessible and computer-readable medium. The instructions when executed by a machine perform, inter alia; processing depicted with respect to the methods 100, 200, and 300 of the FIGS. 1-3, respectively. The VM service life restriction enforcement system 400 is also operational over a network and the network may be wired, wireless, or a combination of wired and wireless.

The VM service life restriction enforcement system 400 includes a VM packager 401 and a VM 402. Each of these will now be discussed in turn.

The VM packager 401 is implemented in a machine-accessible and computer-readable medium and is to process on a machine of the network. Example processing associated with the VM packager 401 was discussed in detail above with reference to the methods 100 and 200 of the FIGS. 1 and 2, respectively.

The VM packager 401 creates a VM image for a software application that includes licensing restrictions. The VM packager 401 also delivers the VM image to the target machine. A VM loader on the target machine then subsequently loads the VM image as the VM 402. The VM 402 has the software application and during the load, the VM loader enforces the licensing restrictions, which are again included with the VM image.

According to an embodiment, VM packager 401 is to embed the licensing restrictions within the VM image as instructions within a VM BIOS that is executed each time the VM 402 is initiated on the target machine via the VM image. This scenario was described in detail above with reference to the method 200 of the FIG. 2.

In another case, the VM packager 401 is to include the licensing restrictions as metadata within the VM image that the VM loader reads and interprets each time the VM 402 is initiated on the target machine via the VM image. This scenario was described in detail above with reference to the method 100 of the FIG. 1.

The VM 402 is implemented in a machine-accessible and computer-readable medium and is to process on a target machine of the network. The VM 402 is created from a VM image, such as the VM images discussed above with reference to the methods 100 and 200 of the FIGS. 1 and 2, respectively. The VM image is created by the VM packager 401 as discussed above and includes licensing restrictions for the software application that processes within the VM 402 on the target machine.

In an embodiment, the VM 402 includes instructions to monitor and further to enforce the licensing restrictions as the VM 402 moves between a kernel mode of operation and a device access mode of operation while the software application processes within the VM 402 on the target machine. Example processing associated with this scenario was discussed in detail above with reference to the method 300 of the FIG. 3.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
packaging a software application as a service within a virtual machine (VM) image;
adding to the VM image licensing restrictions defined by a software vendor for the software application; and
delivering the VM image to a target processing environment from which the VM is to be loaded and processed and the licensing restrictions enforced during the load of the VM within the target processing environment.

2. The method of claim 1, wherein packaging further includes time stamping the VM image with a current time that the software application was packaged within the VM image.

3. The method of claim 2, wherein adding further includes defining the licensing restrictions as a vendor-defined time period during which the software application can be processed within the target processing environment.

4. The method of claim 1, wherein adding further includes defining the licensing restrictions as configurable software licensing agreement preconditions that have to be satisfied before the VM image is loaded and processed within the target processing environment.

5. The method of claim 4, wherein defining further includes representing the configurable software licensing agreement preconditions as one or more of the following: a total number of processors available on the target processing environment limitation, a speed limitation for a network adapted associated with the target processing environment, a temperature limitation for hardware devices associated with the target processing environment, a network throughput limitation for the target processing environment, and an available memory size limitation for the target processing environment.

6. The method of claim 1, wherein delivering further includes initiating a VM loader on the target processing environment to load the VM image and correspondingly to process the software application on the target processing environment.

7. The method of claim 6, wherein initiating further includes reading, by the VM loader, metadata from the VM image, wherein the metadata represents the licensing restrictions, and wherein the VM loader enforces the licensing restrictions as a precondition to loading the VM image into the target processing environment.

8. A machine-implemented method, comprising:
creating a virtual machine (VM) image with a software application and with a Basic Input/Output System (BIOS) that process each time the VM is loaded within a target processing environment;
modifying the BIOS to include instructions for enforcing a licensing restriction against the software application; and
delivering the VM image that has the software application and the modified BIOS to the target processing environment, wherein when the VM is initiated or started on the target processing environment, the modified BIOS instructions process the instructions and enforce the licensing restriction against the software application.

9. The method of claim 8, wherein creating further includes configuring the VM image for processing within the target processing environment in response to software and hardware settings associated with the target processing environment.

10. The method of claim 8, wherein modifying further includes defining the instructions as one or more configurable preconditions necessary to process the software application, wherein the instructions are processed each time the VM is initiated within the target processing environment.

11. The method of claim 8, wherein modifying further includes defining the instructions as a time restriction, wherein the time restriction defines a period within which the software application can be processed and when the software application expires and is not to be processed.

12. The method of claim 11, wherein defining further includes representing the time restriction as a time stamp for when the VM image was created.

13. The method of claim 12, wherein representing further includes adding another instruction that acquires a current time each time the BIOS is processed during startup of the VM image within the target processing environment.

14. The method of claim 13 further comprising, comparing, on the target processing environment, the time stamp against the current time and in response to the compare determining whether the VM image is to be permissibly loaded and initiated on the target processing environment.

15. A machine-implemented method, comprising:
processing a virtual machine (VM) within a target processing environment, wherein the VM includes a software application associated with licensing restrictions and wherein the VM processes on the target processing environment via a user mode, a kernel mode, and a device mode, wherein the licensing restrictions were initially enforced against a VM image having the software application when the VM was initiated and processed within the target processing environment; and
periodically checking the licensing restrictions for the software application when the VM moves between the device access mode of operation and the kernel mode of operation, and when the licensing restrictions are violated taking an action defined by a policy.

16. The method of claim 15 further comprising, restricting access to the device access mode when the licensing restrictions are violated.

17. The method of claim 15 further comprising, granting a grace period for processing the software application when the licensing restrictions are violated in response to the policy.

18. The method of claim 15, wherein periodically checking further includes raising one or more processing exceptions within the target processing environment in response to taking the action, wherein the one or more processing exceptions are defined in the policy.

19. The method of claim 18, wherein raising further includes processing the action to do one or more of the following: trigger an alert to automatically notify an administrator, trigger an automated business workflow application to execute on the target processing environment, and set a condition to terminate the software application on a catastrophic failure detected within the VM.

20. The method of claim 15, wherein periodically checking further includes identifying the licensing restrictions as configured preconditions that are to be satisfied before the software application is permissibly executed within the VM.

21. A system, comprising:
a virtual machine (VM) packager implemented in a machine-accessible and computer-readable medium and to process on a server machine of a network; and
a VM implemented in a machine-accessible and computer-readable medium and to process on a target machine of the network;
wherein the VM packager is to create a VM image for a software application that includes licensing restrictions and delivers the VM image to the target machine, a VM loader on the target machine loads the VM image as the VM having the software application and during the load enforces the licensing restrictions included with the VM image.

22. The system of claim 21, wherein the VM includes instructions to monitor and further to enforce the licensing restrictions as the VM moves between a kernel mode of operation and a device access mode of operation while the software application processes within the VM on the target machine.

23. The system of claim 21, wherein the VM packager is to embed the licensing restrictions within the VM image as instructions within a Basic Input/Output System (BIOS) that is executed each time the VM is initiated on the target machine via the VM image.

24. The system of claim 21, wherein the VM packager is to include the licensing restrictions as metadata within the VM image that the VM loader reads and interprets each time the VM is initiated on the target machine via the VM image.
